(19) United States
(12) Patent Application Publication
(10) Pub. No.: US 2024/0284991 A1
(43) Pub. Date: Aug. 29, 2024

(54) DEVICE WITH CHARGING PADS

(71) Applicant: Nicoventures Trading Limited, London (GB)

(72) Inventors: Damyn MUSGRAVE, London (GB); Conor BRUTON, London (GB); Mohammed AL-AMIN, London (GB)

(21) Appl. No.: 18/568,955

(22) PCT Filed: Jun. 10, 2022
(86) PCT No.: PCT/GB2022/051455

§ 371 Date: Dec. 11, 2023

(30) Foreign Application Priority Data
Jun. 11, 2021 (GB) 2108376.1

(51) Int. Cl. A24F 40/90; A24F 40/40; A24F 40/65; H02J 50/40; H02J 50/80

(52) U.S. Cl. CPC A24F 40/90; A24F 40/40; A24F 40/65; H02J 50/402; H02J 50/80

(57) ABSTRACT

A device (such as an aerosol provision device) is described in which the device has a first side and a second side. The device comprises at least two first contact charging pads on the first side of the device. At least two contact charging pads are accessible on the second side of the device. A method for charging a device is also described. The method comprises placing the device on a charging mat such that at least two contact charging pads provided on a first side of the device are in contact with different charging points of the charging mat.

### RELATED APPLICATIONS

The present application is a National Phase entry of PCT Application No. PCT/GB2022/051455 filed Jun. 10, 2022, which claims priority to GB Application No. 2108376.1 filed Jun. 11, 2021, each of which is herein incorporated by reference in their entirety.

### TECHNICAL FIELD

The present specification relates to a device (such as an aerosol generating device) with charging pads.

### BACKGROUND

Aerosol generating devices, such as an e-cigarettes, have been developed for releasing compounds without requiring combustion. Such devices often include rechargeable batteries. There remains a need for further developments in the charging of such devices.

### SUMMARY

In a first aspect, this specification describes a device (such as an aerosol provision device), wherein the device has a first side and a second side, the device comprising: at least two first contact charging pads on the first side of the device, wherein at least two contact charging pads are accessible on the second side of the device. The device may further comprise at least two second contact charging pads on the second side of the device. The device may be an elongated device.

The first contact charging pads may be accessible from both the first and second sides of the device. Each of the first charging pads may extend around the device; for example, each of the first charging pads may be a ring extending around the device.

The first side may be substantially opposite the second side.

The first and second sides of the device may form part of the same surface of the device.

The device may be configured to transmit data via one or more of said contact charging pads (e.g. using a data over power protocol).

In a second aspect, this specification describes a device comprising at least two first contact charging pads arranged such that an area or point on each of the contact charging pads lie in or on a first common plane. The device may be an elongated device.

The device may further comprise a housing, wherein the housing lies below the first common plane.

The device may have a first side and a second side (which may be on opposite sides of the device), wherein said first contact charging pads are provided on the first side of the device, wherein at least two contact charging pads are accessible on the second side of the device. At least two second contact charging pads may be provided on the second side of the device, wherein the at least two second contact charging pads are arranged such that an area or point on each of the second contact charging pads lie in or on a second common plane. The first contact charging pads may be accessible from both the first and second sides of the device.

The device may be configured to transmit data via one or more of said contact charging pads (e.g. using a data over power protocol).

In a third aspect, this specification describes a non-combustible aerosol provision device comprising a device as described above with reference to the first or second aspects.

In a fourth aspect, this specification describes an aerosol provision device, wherein the aerosol provision device has a first side and a second side, the aerosol provision device comprising: at least two first contact charging pads on the first side of the device, wherein the at least two first contact charging pads are separated from one another by a predetermined distance. The at least two first contact charging pads may be accessible on the second side of the device.

The aerosol provision device may be an elongated device and the at least two first contact charging pads may be separated from one another by the predetermined distance in the direction of the elongation.

Each of the first charging pads may extend around the device.

The device may be configured to transmit data via one or more of said contact charging pads.

In a fifth aspect, this specification describes an electronic smoking article comprising an aerosol provision device as described above with reference to the third or fourth aspects

In a sixth aspect, this specification describes a method of charging a device comprising: placing the device on a charging mat such that at least two contact charging pads provided on a first side of the device are in contact with different charging points of the charging mat. The device may be the device as described above with reference to the first to fourth aspects.

The at least two first contact charging pads may be arranged such that an area or point on each of the contact charging pads lie in or on a first common plane and the device comprises a housing below the first common plane such that the contact charging pads are able to make contact with the charging mat.

At least two contact charging pads may be accessible on a second side of the device.

The method may further comprise transmitting data to or from the device via one or more of said contact charging pads.

### BRIEF DESCRIPTION OF THE DRAWINGS

Example embodiments will now be described, by way of example only, with reference to the following schematic drawings, in which:

FIG. 1 is a block diagram of an aerosol generating device in accordance with an example embodiment;

FIG. 2 is a flow chart showing an algorithm in accordance with an example embodiment;

FIG. 3 is a block diagram of a charging mat in accordance with an example embodiment;

FIG. 4 is a block diagram of a device in accordance with an example embodiment;

FIG. 5 is a cross-section system showing a device being charged in accordance with an example embodiment;

FIG. 6 is a block diagram of a system in accordance with an example embodiment;

FIG. 7 is a flow chart showing an algorithm in accordance with an example embodiment;

FIG. 8 is a block diagram of a device in accordance with an example embodiment;

FIGS. 9A to 9D are cross-sections of devices in accordance with example embodiments;

FIG. 10 is a flow chart showing an algorithm in accordance with an example embodiment;

FIG. 11 is a block diagram of a charging device with an example embodiment; and

FIG. 12 is a block diagram of a device in accordance with an example embodiment.

### DETAILED DESCRIPTION

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavors, one or more aerosol-former materials, and optionally one or more other functional material.

The aerosol-former material may comprise one or more constituents capable of forming an aerosol. In some embodiments, the aerosol-former material may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

A consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

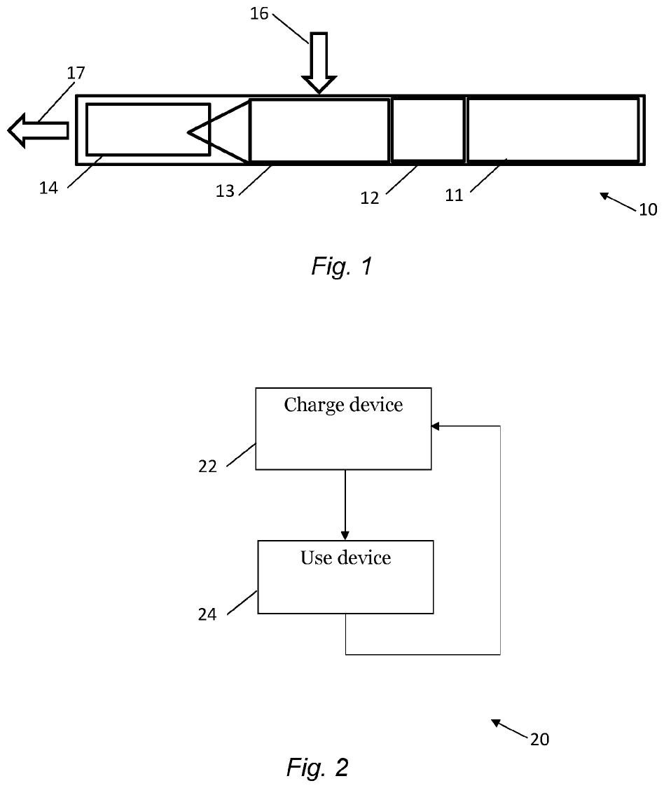

FIG. 1 is a block diagram of an aerosol generating device, indicated generally by the reference numeral 10, in accordance with an example embodiment.

The aerosol generating device 10 comprises a battery 11, a control circuit 12, an aerosol generator which in this example is a heater 13 and an aerosol-generating material storage area which in this example is a liquid reservoir 14 for storing a vaporisable liquid. As discussed in detail below, the battery 11 may be rechargeable.

In the use of the device 10, air is drawn into an air inlet of the heater 13, as indicated by arrow 16. The heater 13 is used to create an aerosol by heating liquid drawn from the liquid reservoir 14. In some devices that user ceramic heaters, liquid is wicked by micro-fluidics of the porous heater material, and some other devices, a dedicated wicking material (such as a fibrous cotton) may be provided to wick liquid to the heater 13. The aerosol exits the device at an air outlet, as indicated by arrow 17 (for example into the mouth of a user of the device 10).

Of course, the aerosol generating device 10 is provided by way of example only and is highly schematic. Many alternative aerosol generating devices and other devices may be used in example implementations of the principles described here.

FIG. 2 is a flow chart showing an algorithm, indicated generally by the reference numeral 20, in accordance with an example embodiment.

The algorithm 20 starts at operation 22, where a battery of a device, such as the aerosol generated device 10 described above, is charged. At operation 24, the device is used. Use of the device may include any such use of the device which requires electrical power (e.g., from the battery) and is not limited solely to aerosol generation. A number of arrangements are possible for charging the device in the operation 22. The device 10 is able to return to the charging operation 22, for example when the battery 11 is fully or partially depleted. In some example embodiments, it may be advantageous to allow the device to be charged whilst the device is being used.

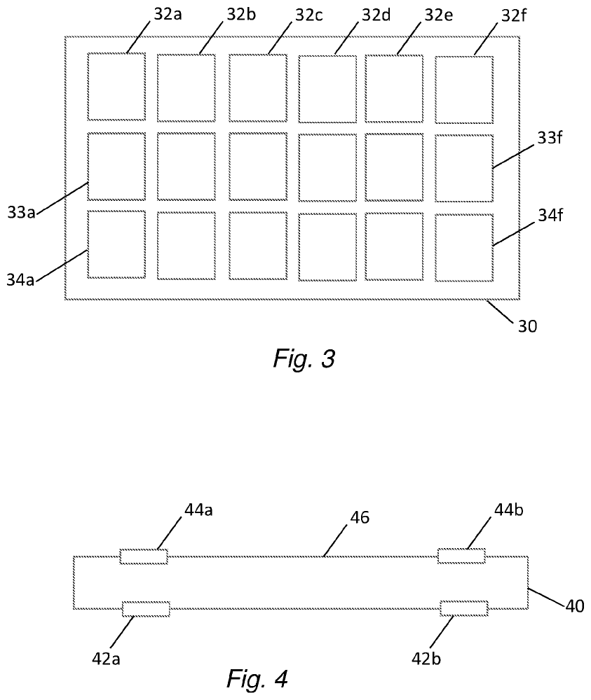

FIG. 3 is a block diagram of a charging mat 30 in accordance with an example embodiment. As discussed further below, the charging mat 30 may be used to charge a battery of a device through contact charging, thereby implementing the operation 22 of the algorithm 20 described above.

The mat 30 comprises a plurality of contact charging points. A first row of contact charging points 32a to 32f is labelled in FIG. 3. A second row of contact charging points includes contact charging points 33a to 33f (of which only contact charging points 33a and 33f are labelled) and a third row of contact charging points 34a to 34f (of which only contact charging points 34a and 34f are labelled).

The mat 30 may have more or fewer contact charging points than those shown in FIG. 3. For example, the mat may have any number of rows and each row may have any number of contact charging points. Moreover, the distribution of contact charging points may be different to that shown in the mat 30; for example, different rows may include different numbers of contact charging points. Some or all of the contact charging points may be shaped differently to the shapes shown in FIG. 3 (e.g. they could be shaped to aid alignment and locating of the device to be charged).

Each contact charging point can be coupled with a contact charging pad of a device to be charged. More specifically, the mat 30 comprises at least two charging points for coupling with at least two contact charging pads of a device to be charged.

FIG. 4 is a block diagram of a device 40 in accordance with an example embodiment. The device 40 is a device (such as an aerosol generating device) having a first side and a second side (which sides are opposite one another in the example device 40). A pair of first contact charging pads 42a and 42b are provided on the first side of the device 40. A pair of second contact charging pads 44a and 44b are provided on the second side of the device 40. Thus, contact charging pads are accessible from both the first and second sides of the device 40. By providing contact charging pads on different sides of the device 40, the device can be charged in different orientations, which may be convenient for a user. In the example of FIG. 4, the device 40 is elongated and each of the pairs of contact pads 42a, 42b and 44a, 44b are provided at or adjacent to the respective ends of the device in the direction of elongation. However, other configurations of the device (e.g. non-elongated configurations) are possible. Moreover the “sides” on which the contact charging pads are provided may be different to those shown in FIG. 4; for example, the contact charging pads may be provided on the ends of the device 40, with the first pair of contact charging pads being provided on one end and the second pair of contact charging pads being provided on the other end.

The first charging pads 42a and 42b of the device 40 are arranged such that an area or point on each of the contact charging pads lie in or on a first common plane. Similarly, the second charging pads 44a and 44b are arranged such that an area or point on each of the contact charging pads lie in or on a second common plane. Moreover, the device 40 includes a housing 46, wherein the housing lies below said common planes such that the contact charging pads are able to make contact with contact charging points of a charging mat, such as the mat 30 described above.

It should be noted that the device 40 is provided by way of example only and many alternative arrangements are possible. For example, although the device 40 provides a flat planar surface comprising charging contacts, this is not essential to all example embodiments. The principles described herein are applicable to a range of geometries where the charging device and the device being charged are not flat. For example, the charger may have a recess that provides allocating features, or an appendage of device to be charged.

The device 40 may be an aerosol provision device (such as the device 10 described above). The contact charging pads of the device 40 may be used to charge a battery of the device 40, as discussed further below.

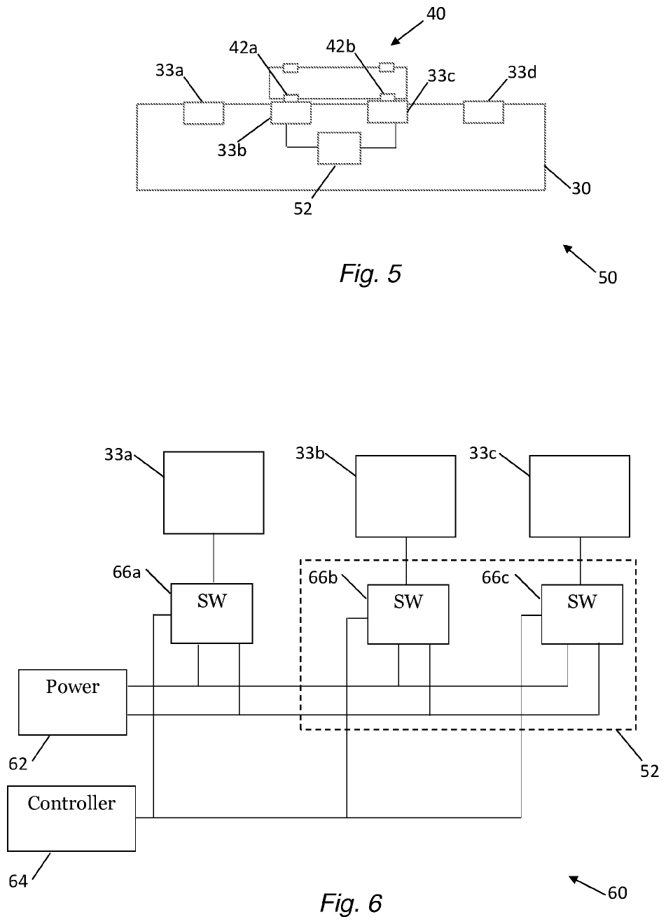

FIG. 5 is a cross-section of a system, indicated generally by the reference numeral 50, showing a device being charged in accordance with an example embodiment. More specifically, the system 50 shows the mat 30 being used to charge the device 40.

The cross-section of the system 50 shows contact charging points 33a, 33b, 33c and 33d that form part of the second row of contact charging points 33a to 33f described above. The device 40 is positioned such that the contact charging pad 42a is in contact with the contact charging point 33b and the contact charging pad 42b is in contact with the contact charging point 33c. Note that this connection can readily be reversed (so that the contact charging pad 42a is in contact with the contact charging point 33c and the contact charging pad 42b is in contact with the contact charging point 33b). Thus, the system 50 provides a great deal of flexibility.

The system 50 further comprises a charging arrangement 52 that is used to couple the charging points 33b and 33c for charging the device 40, as discussed further below.

FIG. 6 is a block diagram of a system, indicated generally by the reference numeral 60, in accordance with an example embodiment.

The system 60 includes the contact charging points 33a, 33b and 33c described above. The system 60 further comprise a power source 62, a controller 64, first, second and third switching modules 66a to 66c. As discussed further below, the second and third switching modules 66b and 66c form the charging arrangement 52 described above. Clearly, multiple charging arrangements are provided between the various combinations of contact charging points of the system.

The power source 62 and the controller 64 are both connected to each of the first to third switching modules 66a, 66b and 66c. The first switching module 66a is coupled to the contact charging point 33a. Similarly, the second switching module 66b is coupled to the contact charging point 33b and the third switching module 66c is coupled to the contact charging point 33c.

The controller 64 controls the switching modules so that power can be provided between pairs of contact charging points in order to charge a battery of a device (such as the device 40) that is in contact with the respective charging points. The controller 64 can also be used to ensure that the correct voltage magnitude and polarity is applied via the switching modules, according to the device being charged.

By way of example, the charging arrangement 52 can be controlled to activate the second switching module 66b and the third switching module 66c so that power from the power source 62 is provided across the contact charging points 33b and 33c so that the device 40 can be charged. Unused charging points are held at high resistance or at a safe voltage.

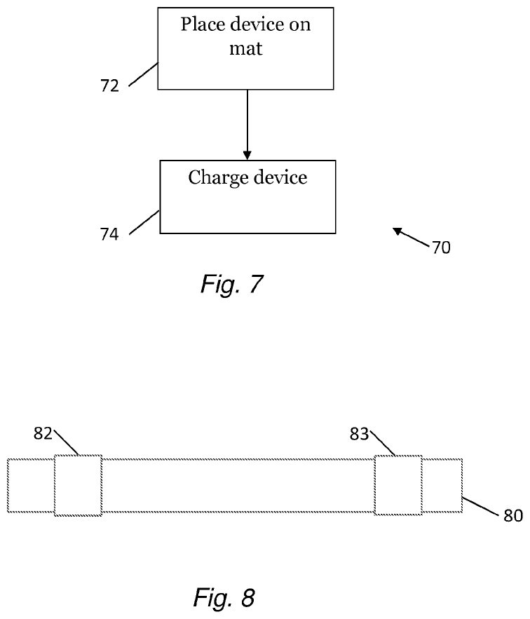

FIG. 7 is a flow chart showing an algorithm, indicated generally by the reference numeral 70, in accordance with an example embodiment.

The algorithm 70 starts at operation 72, where a device (e.g. an aerosol generating device) is placed on a charging mat such that at least two contact charging pads provided on a first side of the device are in contact with different contact charging points of the charging mat. The flexibility of the switching arrangement described above can be used to enable the device to be placed in contact with any combination (e.g. any pair) of charging points.

By way of example, the operation 72 may be implemented by placing the device 40 on the charging mat 30 such that the contact charging pads 42a and 42b of the device 40 are in contact with the contact charging points 33b and 33c of the charging mat, as shown in FIG. 5.

At operation 74, the device placed on the charging mat is charged. The operation 74 may be implemented by the switching modules of the system 60, under the control of the controller 64.

The configuration of the contact charging pads of the device 40 is one of many example implementations. In the device 40, two first contact charging pads are provided on the first side of the device and two different contact charging pads are provided on the other side of the device. This is not essential to all example embodiments. For example, charging pads may be accessible to both on both the first and second sides of the device in some other way. For example, the first contact charging pads (provided on the first side of the device) may be accessible from both the first and second sides of the device (e.g. by extend around the device).

FIG. 8 is a block diagram of a device 80 in accordance with an example embodiment. The device 80 is an elongated device (such as an aerosol generating device) having a first side and a second side (which sides are opposite one another in the example device 40). A pair of contact charging pads 82 and 83 are provided that are accessible from both the first and second sides of the device 40. Specifically, the contact charging pads 82 and 83 are rings that extend around the device 80.

The devices 40 and 80 described above are devices (e.g. elongated devices) having first and second sides. The cross-section of those devices may take many different forms.

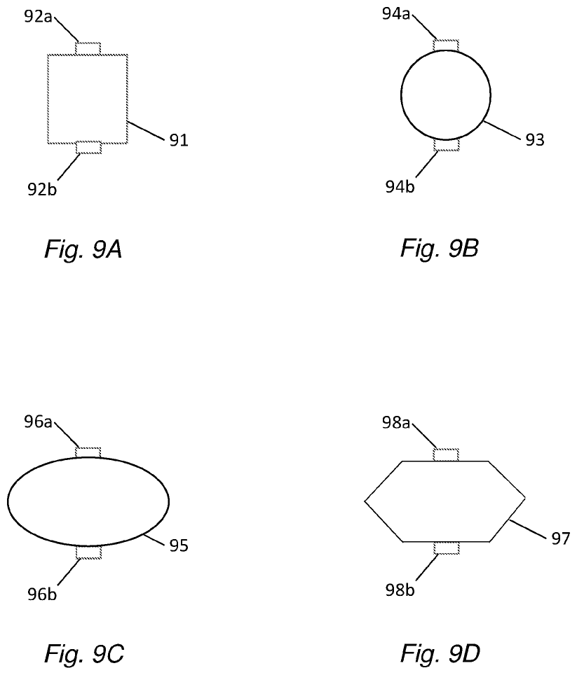

FIGS. 9A to 9D are cross-sections of devices in accordance with example embodiments.

FIG. 9A shows a device 91 having a square cross-section with a first contact charging pad 92a and a second contact charging pad 92b provided on opposite first and second sides of the device.

FIG. 9B shows a device 93 having a circular cross-section with a first contact charging pad 94a and a second contact charging pad 94b provided on opposite first and second sides of the device. Thus, the first and second sides of the device may form part of the same surface of the device, for example forming a cylindrical, pen-like device.

FIG. 9C shows a device 95 having an oval cross-section with a first contact charging pad 96a and a second contact charging pad 96b provided on opposite first and second sides of the device.

FIG. 9D shows a device 97 having a more complex cross-section with a first contact charging pad 98a and a second contact charging pad 98b provided on opposite first and second sides of the device.

Of course, the devices 91 to 94 are provided by way of example only. Many alternative cross-sectional shapes could be provided in alternative embodiments.

In addition to charging a device having contact charging pads in contact with contact charging points, the system 60 (or some similar system) can be used to transmit data to or from the device via a contact charging point.

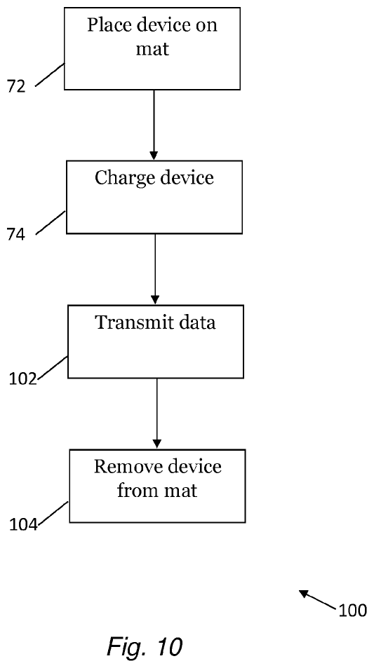

FIG. 10 is a flow chart showing an algorithm, indicated generally by the reference numeral 100, in accordance with an example embodiment.

The algorithm 100 starts at operation 72, where, as discussed above, a device (e.g. an aerosol generating device) is placed on a charging mat such that at least two contact charging pads provided on a first side of the device are in contact with different contact charging points of the charging mat.

At operation 74, the device placed on the charging mat is charged. As discussed above, the operation 74 may be implemented by the switching modules of the system 60, under the control of the controller 64.

At operation 102, data is transmitted either by the device placed on the charging mat, or to the device placed on the charging mat. The data is transmitted via one or more of said contact charging pads. For example, the data may be transmitted using a data over power protocol. Thus, the device may be charged whilst transmitting and/or receiving data.

At operation 104, the device is removed from the mat.

As discussed above, charging contact points may be provided as part of a charging mat. This is not essential to all example embodiments. Charging points may be provided in many different ways.

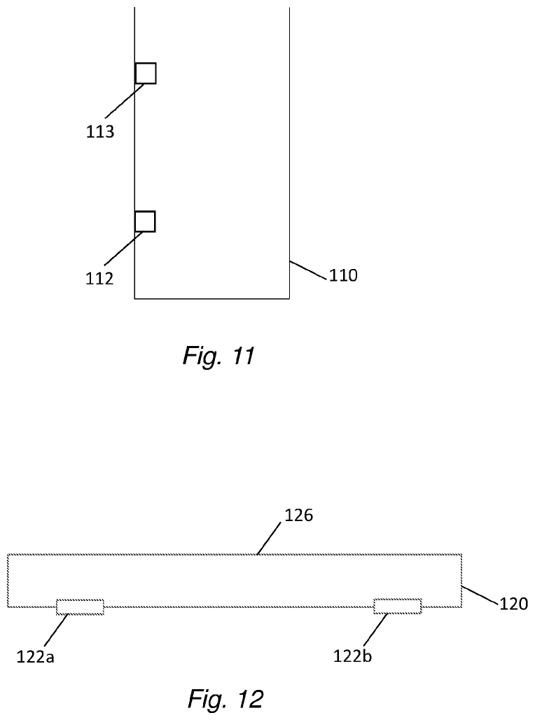

FIG. 11 is a block diagram of a charging device, indicated generally by the reference numeral 110, with an example embodiment. The charging device 110 is shaped to enable a device, such as the device 40 or 80 described above, to be retained within the device 110. The charging device 110 includes a first contact charging point 112 and a second contact charging point 113 for coupling with contact charging pads of a device for charging. In use. The charging device 110 may be placed on a user's desk to enable convenient charging of a device.

Of course, the mat 30 and the charging device 110 are provided by way of example only. Many variants are possible.

In the example embodiments described above, contact charging pads are provided on the first side of a device and contact charging pads are accessible on the second side of the device. This is not essential to all example embodiments. For example, a device (such as an aerosol provision device) may be provided having a first side and a second side, the device having at least two first contact charging pads on the first side of the device, wherein the at least two first contact charging pads are separated from one another by a predetermined distance.

By way of example, FIG. 12 is a block diagram of a device 120 (such as an aerosol provision device) in accordance with an example embodiment. The device 120 has a first side and a second side (which sides are opposite one another in the example device 120). A pair of first contact charging pads 122a and 122b (similar to the contact charging pads 42a and 42b described above) are provided on the first side of the device 40 and are separated from one another by a predetermined distance. In the example of FIG. 12, the device 120 is elongated and each of the pairs of contact pads 42a, 42b and 44a, 44b are provided at or adjacent to the respective ends of the device in the direction of elongation. However, other configurations of the device (e.g. non-elongated configurations) are possible.

The first charging pads 122a and 122b of the device 40 may be arranged such that an area or point on each of the contact charging pads lie in or on a first common plane. Moreover, the device 40 includes a housing 126, wherein the housing lies below said common plane such that the contact charging pads are able to make contact with contact charging points of a charging mat, such as the mat 30 described above.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A device, wherein the device has a first side and a second side, the device comprising:
at least two first contact charging pads on the first side of the device, wherein at least two contact charging pads are accessible on the second side of the device.

2. A device as claimed in claim 1, wherein the device is an aerosol provision device.

3. A device as claimed in claim 1, further comprising at least two second contact charging pads on the second side of the device.

4. A device as claimed in claim 1, wherein the first contact charging pads are accessible from both the first and second sides of the device.

5. A device as claimed in claim 4, wherein each of the first charging pads extend around the device.

6. A device as claimed in claim 5, wherein each of the first charging pads is a ring extending around the device.

7. A device as claimed in claim 1, wherein the first side is substantially opposite the second side.

8. A device as claimed in claim 1, wherein the first and second sides of the device form part of the same surface of the device.

9. A device comprising at least two first contact charging pads arranged such that an area or point on each of the contact charging pads lie in or on a first common plane.

10. A device as claimed in claim 9, further comprising a housing, wherein the housing lies below the first common plane.

11. A device as claimed in claim 9, wherein the device has a first side and a second side, wherein said first contact charging pads are provided on the first side of the device, wherein at least two contact charging pads are accessible on the second side of the device.

12. A device as claimed in claim 11, further comprising at least two second contact charging pads on the second side of the device, wherein the at least two second contact charging pads are arranged such that an area or point on each of the second contact charging pads lie in or on a second common plane.

13. A device as claimed in claim 11, wherein the first contact charging pads are accessible from both the first and second sides of the device.

14. A device as claimed in claim 1, wherein the device is configured to transmit data via one or more of said contact charging pads.

15. A device as claimed in claim 14, wherein said data is transmitted using a data over power protocol.

16. A device as claimed in claim 1, wherein the device is an elongated device.

17. A non-combustible aerosol provision device comprising a device as claimed in claim 1.

18. An aerosol provision device, wherein the aerosol provision device has a first side and a second side, the aerosol provision device comprising:
at least two first contact charging pads on the first side of the device, wherein the at least two first contact charging pads are separated from one another by a predetermined distance.

19. A device as claimed in claim 18, wherein the aerosol provision device is an elongated device and the at least two first contact charging pads are separated from one another by the predetermined distance in the direction of the elongation.

20. A device as claimed in claim 18, wherein at least two first contact charging pads are accessible on the second side of the device.

21. A device as claimed in claim 18, wherein each of the first charging pads extend around the device.

22. A device as claimed in claim 18, wherein the device is configured to transmit data via one or more of said contact charging pads.

23. An electronic smoking article comprising an aerosol provision device as claimed in claim 17.

24. A method of charging a device comprising:
placing the device on a charging mat such that at least two contact charging pads provided on a first side of the device are in contact with different charging points of the charging mat.

25. A method as claimed in claim 24, wherein the at least two first contact charging pads are arranged such that an area or point on each of the contact charging pads lie in or on a first common plane and the device comprises a housing below the first common plane such that the contact charging pads are able to make contact with the charging mat.

26. A method as claimed in claim 24, wherein at least two contact charging pads are accessible on a second side of the device.

27. A method as claimed in claim 24, further comprising transmitting data to or from the device via one or more of said contact charging pads.
